(19) United States
(12) Patent Application Publication
(10) Pub. No.: US 2026/0063964 A1
(43) Pub. Date: Mar. 5, 2026

(54) OPTICAL MODULATOR

(71) Applicant: SUMITOMO ELECTRIC INDUSTRIES, LTD., Osaka (JP)

(72) Inventors: Hajime TANAKA, Osaka (JP); Naoki FUJIWARA, Osaka (JP)

(73) Assignee: SUMITOMO ELECTRIC INDUSTRIES, LTD., Osaka (JP)

(21) Appl. No.: 19/312,389

(22) Filed: Aug. 28, 2025

(30) Foreign Application Priority Data
Sep. 4, 2024 (JP) 2024-152326

(51) Int. Cl. G02F 1/225; G02F 1/21

(52) U.S. Cl. CPC G02F 1/2257; G02F 1/212; G02F 1/2255

(57) ABSTRACT

An optical modulator includes an optical waveguide structure extending along a first direction. The optical waveguide structure includes a first III-V compound semiconductor layer of a first conductivity type, a second III-V compound semiconductor layer of a second conductivity type, a core layer disposed between the first III-V compound semiconductor layer and the second III-V compound semiconductor layer, and a periodic structure layer. The first III-V compound semiconductor layer is disposed between the periodic structure layer and the core layer. The periodic structure layer includes a first portion and a second portion that are alternately disposed in the first direction. The first portion has a refractive index larger than a refractive index of the first III-V compound semiconductor layer. The second portion has a refractive index smaller than a refractive index of the first portion.

### CROSS REFERENCE TO RELATED APPLICATIONS

This application claims priority based on Japanese Patent Application No. 2024-152326 filed on Sep. 4, 2024, and the entire contents of the Japanese patent application are incorporated herein by reference.

### TECHNICAL FIELD

The present disclosure relates to an optical modulator.

### BACKGROUND

Patent Literature (Japanese Unexamined Patent Application Publication No. 2021-33042) discloses a Mach-Zehnder optical modulator. The optical modulator includes a substrate formed of indium phosphide (InP). Two arm waveguides are formed on the substrate. In each arm waveguide, a lower contact layer, a lower cladding layer, a core layer, an upper cladding layer, and an upper contact layer are stacked in this order. The lower contact layer and the lower cladding layer are formed of n-type InP doped with silicon. The core layer has a multiple quantum well structure. The upper cladding layer is formed of p-type InP doped with zinc. The upper contact layer is formed of p-type indium gallium arsenide (InGaAs) doped with zinc.

### SUMMARY

An optical modulator according to one aspect of the present disclosure includes an optical waveguide structure extending along a first direction. The optical waveguide structure includes a first III-V compound semiconductor layer of a first conductivity type, a second III-V compound semiconductor layer of a second conductivity type, a core layer disposed between the first III-V compound semiconductor layer and the second III-V compound semiconductor layer, and a periodic structure layer. The first III-V compound semiconductor layer is disposed between the periodic structure layer and the core layer. The periodic structure layer includes a first portion and a second portion that are alternately disposed in the first direction. The first portion has a refractive index larger than a refractive index of the first III-V compound semiconductor layer. The second portion has a refractive index smaller than a refractive index of the first portion.

### BRIEF DESCRIPTION OF THE DRAWINGS

FIG. 1 is a plan view schematically showing an optical modulator according to an embodiment.

FIG. 2 is a plan view schematically showing a part of the optical modulator of FIG. 1.

FIG. 3 is a cross-sectional view taken along line III-III of FIG. 2.

FIG. 4 is a cross-sectional view taken along line IV-IV of FIG. 2.

FIG. 5 is a cross-sectional view schematically showing a modification of an optical waveguide structure.

FIG. 6 is a plan view schematically showing a part of the optical modulator of FIG. 1.

FIG. 7 is a cross-sectional view taken along line VII-VII of FIG. 6.

FIG. 8 is a graph showing an example of a group refractive index when a pitch is changed.

FIG. 9 is a graph showing an example of a group refractive index when a thickness of an upper cladding layer is changed.

FIG. 10 is a graph showing an example of a group refractive index with when a thickness of a lower cladding layer is changed.

FIG. 11 is a graph showing an example of a group refractive index with when a thickness of a core layer is changed.

### DETAILED DESCRIPTION

In the optical modulator of Patent Literature 1, since the arm waveguide is formed of a III-V compound semiconductor layer, a refractive index of the arm waveguide cannot be increased.

The present disclosure provides an optical modulator including an optical waveguide structure having a high refractive index.

### [Description of Embodiments of Present Disclosure]

First, the contents of the embodiments of the present disclosure will be listed and described.

(1) An optical modulator according to one embodiment includes an optical waveguide structure extending along a first direction. The optical waveguide structure includes a first III-V compound semiconductor layer of a first conductivity type, a second III-V compound semiconductor layer of a second conductivity type, a core layer disposed between the first III-V compound semiconductor layer and the second III-V compound semiconductor layer, and a periodic structure layer. The first III-V compound semiconductor layer is disposed between the periodic structure layer and the core layer. The periodic structure layer includes a first portion and a second portion that are alternately disposed in the first direction. The first portion has a refractive index larger than a refractive index of the first III-V compound semiconductor layer. The second portion has a refractive index smaller than a refractive index of the first portion.

According to the optical modulator, a refractive index of the optical waveguide structure can be increased by the periodic structure layer having a high refractive index.

(2) In the above (1), the first portion may have a width smaller than a width of the first III-V compound semiconductor layer.

In this case, the periodic structure layer can confine light in a width direction.

(3) In the above (1) or (2), the first portion may include silicon.

(4) In any one of the above (1) to (3), the second portion may include an air gap or silicon oxide.

(5) In any one of (1) to (4), the first portion may be disposed at a pitch smaller than a pitch equivalent to a wavelength of light propagating through the core layer in the first direction.

In this case, light can propagate through the periodic structure layer in the first direction.

(6) In any one of the above (1) to (5), the first III-V compound semiconductor layer may have a thickness smaller than a thickness of the core layer.

In this case, light is likely to leak from the core layer to the periodic structure layer through the first III-V compound semiconductor layer.

(7) In any one of the above (1) to (6), the second III-V compound semiconductor layer may have a thickness of 0.4 μm or less.

In this case, a high group refractive index is obtained.

(8) In any one of the above (1) to (7), the optical modulator may further include a substrate.

The periodic structure layer may be disposed between the substrate and the first III-V compound semiconductor layer.

(9) In any one of the above (1) to (8), the optical waveguide structure may include a first region, a second region, and a third region, the first region, the second region, and the third region may be arranged along the first direction. The first region may be located at an end portion of the optical waveguide structure in the first direction, the second region may be disposed between the first region and the third region, the periodic structure layer may include the first portion and the second portion in the third region, the periodic structure layer may include a third portion extending in the first direction in the first region, the third portion may have a refractive index larger than the refractive index of the first III-V compound semiconductor layer. In the second region, the periodic structure layer may include the first portion, the second portion, and a fourth portion extending in the first direction, and the fourth portion may have a tapered shape with a width that decreases from the first region toward the third region.

In this case, light can propagate through the periodic structure layer from the first region to the third region.

(10) In the above (9), the first III-V compound semiconductor layer may have a first tapered portion in the first region, the first tapered portion may have a width that increases from the first region toward the third region, the core layer may have a second tapered portion in the first region, the second tapered portion may have a width that increases from the first region toward the third region, each of the first tapered portion and the second tapered portion may have a tip end on or above the third portion of the periodic structure layer, and in the first direction, the tip end of the second tapered portion may be located closer to the second region than the tip end of the first tapered portion.

In this case, in the first region, light can propagate from the third portion of the periodic structure layer to the second tapered portion through the first tapered portion.

### [Details of Embodiments of Present Disclosure]

Hereinafter, embodiments of the present disclosure will now be described in detail with reference to the accompanying drawings. In the description of the drawings, the same reference numerals are used for the same or equivalent elements, and redundant description will be omitted. In the drawings, an X-axis direction, a Y-axis direction, and a Z-axis direction that intersect each other are shown as necessary. The X-axis direction, the Y-axis direction, and the Z-axis direction are, for example, orthogonal to each other.

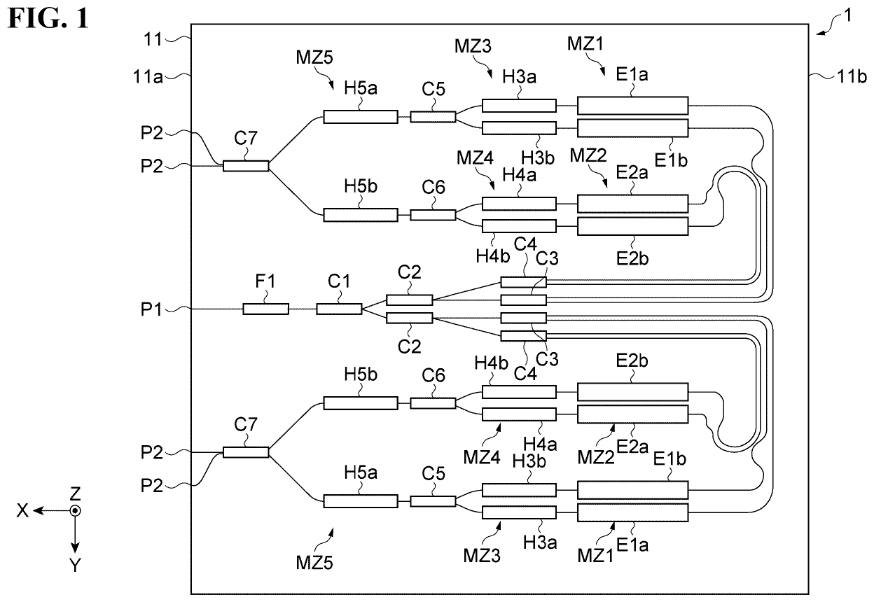

FIG. 1 is a plan view schematically showing an optical modulator according to the embodiment. An optical modulator 1 can modulate the intensity or phase of light in optical communication, for example, to generate a modulation signal. The optical modulator 1 may include an input port P1, a plurality of Mach-Zehnder modulator portions MZ1, MZ2, MZ3, MZ4, and MZ5, an optical filter F1, a plurality of optical couplers C1, C2, C3, C4, C5, C6, and C7, and a plurality of output ports P2. The input port P1, the plurality of Mach-Zehnder modulator portions MZ1 to MZ5, the optical filter F1, the plurality of optical couplers C1 to C7, and the plurality of output ports P2 may be provided on a substrate 11.

The substrate 11 extends along the X-axis direction and the Y-axis direction. A major surface of the substrate 11 may have a substantially rectangular shape. The major surface of the substrate 11 includes an edge 11a extending in the Y-axis direction and an edge 11b extending in the Y-axis direction. The edge 11b is located opposite to the edge 11a of the substrate 11 in the X-axis direction. The edge 11a may be provided with the input port P1 and the plurality of output ports P2. The input port P1 is located in the middle of the plurality of output ports P2.

The input port P1 is optically coupled to the optical filter F1 by an optical waveguide. The optical filter F1 is, for example, an optical component with one input one output. The optical filter F1 is optically coupled to the optical coupler C1 by an optical waveguide. The optical coupler C1 is, for example, an MMI (Multi-Mode Interface) coupler with one input and two outputs. The optical coupler C1 is optically coupled to the plurality (for example, two) of optical couplers C2 by a plurality (for example, two) of the optical waveguides. Each optical coupler C2 is, for example, an MMI coupler with one input and two outputs. Each optical coupler C2 is optically coupled to optical couplers C3 and C4 by a plurality (for example, two) of optical waveguides. Each of the optical couplers C3 and C4 is, for example, an MMI coupler with one input and two outputs.

The optical coupler C3 is optically coupled to a first arm waveguide and a second arm waveguide of the Mach-Zehnder modulator portion MZ1 by a plurality (for example, two) of optical waveguides. An electrode Ela for modulation is provided on the first arm waveguide of the Mach-Zehnder modulator portion MZ1. An electrode E1b for modulation is provided on the second arm waveguide of the Mach-Zehnder modulator portion MZ1.

The first arm waveguide and the second arm waveguide of the Mach-Zehnder modulator portion MZ1 are optically coupled to a first arm waveguide and a second arm waveguide of a Mach-Zehnder modulator portion MZ3, respectively, by a plurality (for example, two) of optical waveguides. A heater H3a is provided on the first arm waveguide of the Mach-Zehnder modulator portion MZ3. A heater H3b is provided on the second arm waveguide of the Mach-Zehnder modulator portion MZ3.

The first arm waveguide and the second arm waveguide of the Mach-Zehnder modulator portion MZ3 are optically coupled to an optical coupler C5 by a plurality (for example, two) of optical waveguides. The optical coupler C5 is, for example, an MMI coupler with two inputs and one output. The optical coupler C5 is optically coupled to a first arm waveguide of a Mach-Zehnder modulator portion MZ5 by an optical waveguide. A heater H5a is provided on the first arm waveguide of the Mach-Zehnder modulator portion MZ5. One optical coupler C3, one Mach-Zehnder modulator portion MZ1, one Mach-Zehnder modulator portion MZ3, and one optical coupler C5 constitute one sub-Mach-Zehnder modulator.

An optical coupler C4 is optically coupled to a first arm waveguide and a second arm waveguide of a Mach-Zehnder modulator portion MZ2 by a plurality (for example, two) of optical waveguides. An electrode E2a for modulation is provided on the first arm waveguide of the Mach-Zehnder modulator portion MZ2. An electrode E2b for modulation is provided on the second arm waveguide of the Mach-Zehnder modulator portion MZ2.

The first arm waveguide and the second arm waveguide of the Mach-Zehnder modulator portion MZ2 are optically coupled to a first arm waveguide and a second arm waveguide of a Mach-Zehnder modulator portion MZ4, respectively, by a plurality (for example, two) of optical waveguides. A heater H4a is provided on the first arm waveguide of the Mach-Zehnder modulator portion MZ4. A heater H4b is provided on the second arm waveguide of the Mach-Zehnder modulator portion MZ4. One optical coupler C4, one Mach-Zehnder modulator portion MZ2, one Mach-Zehnder modulator portion MZ4, and one optical coupler C6 constitute one sub-Mach-Zehnder modulator.

The first arm waveguide and the second arm waveguide of the Mach-Zehnder modulator portion MZ4 are optically coupled to the optical coupler C6 by a plurality (for example, two) of optical waveguides. The optical coupler C6 is, for example, an MMI coupler with two inputs and one output. The optical coupler C6 is optically coupled to a second arm waveguide of the Mach-Zehnder modulator portion MZ5 by an optical waveguide. A heater H5b is installed on the second arm waveguide of the Mach-Zehnder modulator portion MZ5.

The first arm waveguide and the second arm waveguide of the Mach-Zehnder modulator portion MZ5 are optically coupled to an optical coupler C7 by a plurality (for example, two) of optical waveguides. The optical coupler C7 is, for example, an MMI coupler with two inputs and two outputs. The optical coupler C7 is optically coupled to a plurality (for example, two) of output ports P2 by a plurality (for example, two) of optical waveguides, respectively.

The optical modulator 1 includes four sub-Mach-Zehnder modulators. After light is input to the input port P1, the light is output from the output ports P2 via the Mach-Zehnder modulator portions MZ1 to MZ5. The light is converted into four different signal lights by the four sub-Mach-Zehnder modulators. The four signal lights are multiplexed by two optical couplers C7. The four signal lights are multiplexed and output from two output ports P2 of the four output ports P2. Each of the Mach-Zehnder modulator portions MZ1 and MZ2 may include an arm waveguide including a III-V compound semiconductor. By applying a high-frequency voltage between the electrodes E1a, E1b, E2a, and E2b and the ground electrode, a refractive index of each of the arm waveguides can be changed. On the other hand, each of the Mach-Zehnder modulator portions MZ3 to MZ5 may include an arm waveguide including silicon. By heating the arm waveguides by the heaters H3a, H3b, H4a, H4b, H5a, and H5b, a refractive index of each of the arm waveguides can be changed. The heaters H3a, H3b, H4a, H4b, H5a, and H5b may be conductor patterns for performing resistance heating.

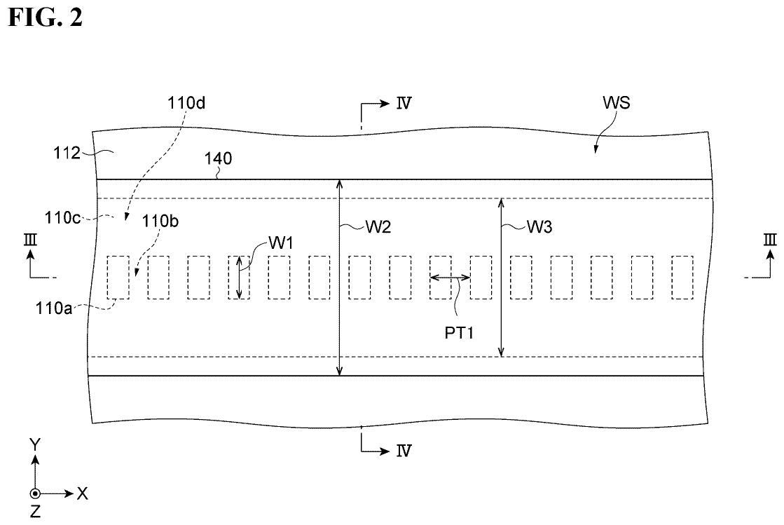

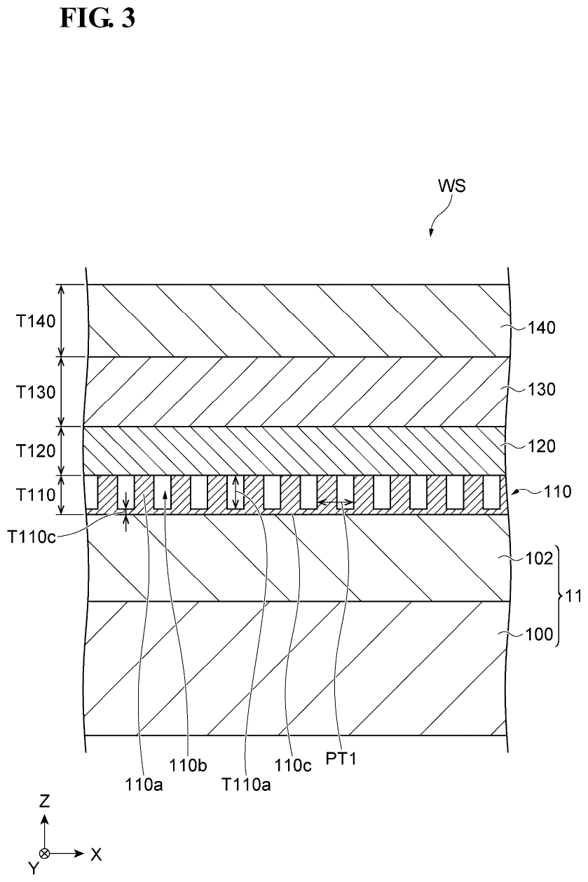

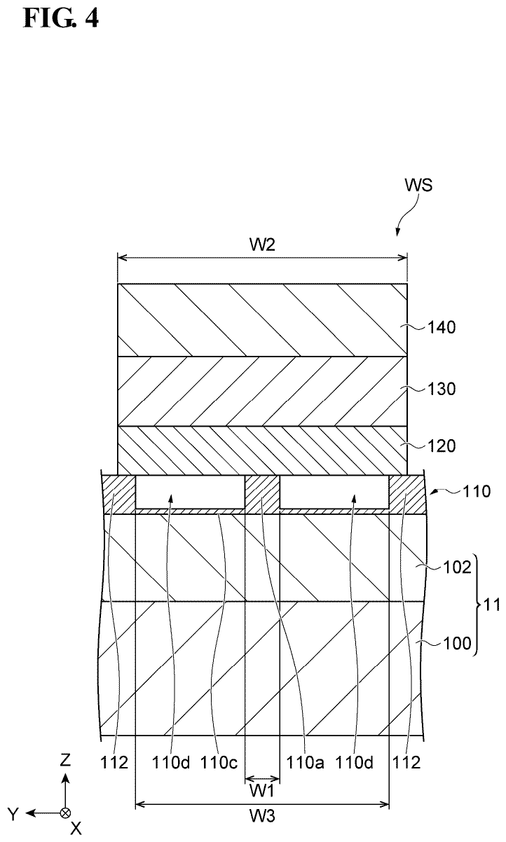

FIG. 2 is a plan view schematically showing a part of the optical modulator of FIG. 1. FIG. 2 shows a part of the first arm waveguide of the Mach-Zehnder modulator portion MZ1. FIG. 3 is a cross-sectional view taken along line III-III of FIG. 2. FIG. 4 is a cross-sectional view taken along line IV-IV of FIG. 2. As shown in FIGS. 2 to 4, the first arm waveguide of the Mach-Zehnder modulator portion MZ1 includes an optical waveguide structure WS extending along the X-axis direction (first direction). The X-axis direction may be a traveling direction of light. Each of the second arm waveguide of the Mach-Zehnder modulator portion MZ1, the first arm waveguide and the second arm waveguide of the Mach-Zehnder modulator portion MZ2 may include the optical waveguide structure WS.

The optical waveguide structure WS includes a periodic structure layer 110, a first III-V compound semiconductor layer 120 of a first conductivity type (for example, n-type), a core layer 130, and a second III-V compound semiconductor layer 140 of a second conductivity type (for example, p-type). The second conductivity type is a conductivity type opposite to the first conductivity type. The periodic structure layer 110 may be disposed between the substrate 11 and the first III-V compound semiconductor layer 120. The first III-V compound semiconductor layer 120 is disposed between the periodic structure layer 110 and the core layer 130. The core layer 130 is disposed between the first III-V compound semiconductor layer 120 and the second III-V compound semiconductor layer 140.

The substrate 11 may include a silicon substrate 100 and a silicon oxide layer 102 on the silicon substrate 100. The silicon oxide layer 102 is disposed between the silicon substrate 100 and the periodic structure layer 110. A thickness of the silicon substrate 100 may be 100 μm or more. A thickness of the silicon oxide layer 102 may be 2 μm or more.

The periodic structure layer 110 includes a first portion 110a and a second portion 110b that are alternately disposed in the X-axis direction. The first portion 110a and the second portion 110b may be periodically disposed in the X-axis direction. The first portion 110a has a refractive index larger than a refractive index of the first III-V compound semiconductor layer 120. The first portion 110a may include silicon. The first portion 110a may be a portion filled with silicon. The second portion 110b has a refractive index smaller than a refractive index of the first portion 110a. The refractive index of the second portion 110b may be smaller than the refractive index of the first III-V compound semiconductor layer 120. The second portion 110b may include an air gap (air) or silicon oxide. The second portion 110b may be a portion occupied by air or a portion filled with silicon oxide.

The first portion 110a may be disposed at a pitch PT1 smaller than a pitch equivalent to a wavelength (for example, 1.55 μm) of light propagating through the core layer 130 in the X-axis direction. The pitch PT1 may be 0.3 to 0.33 μm. The pitch PT1 is a total value of a length of the first portion 110a in the X-axis direction and a length of the second portion 110b in the X-axis direction. The length of the first portion 110a in the X-axis direction may be the same as or different from the length of the second portion 110b in the X-axis direction.

Each of the first portion 110a and the second portion 110b may have a width W1 that is smaller than a width W2 of each of the first III-V compound semiconductor layer 120, the core layer 130, and the second III-V compound semiconductor layer 140. The width W1 is a length of each of the first portion 110a and the second portion 110b in the Y-axis direction. The width W1 may be 0.3 to 1.0 μm. Each of the first portion 110a and the second portion 110b may have a thickness T110a. The thickness T110a is a length of each of the first portion 110a and the second portion 110b in the Z-axis direction. The thickness T110a may be 0.1 to 0.5 μm.

The periodic structure layer 110 may further include a base layer 110c extending along the X-axis direction. The first portion 110a and the second portion 110b are disposed between the base layer 110c and the first III-V compound semiconductor layer 120. An example of the material of the base layer 110c is the same as an example of the material of the first portion 110a. The base layer 110c may have a thickness T110c smaller than the thickness T110a. The thickness T110c may be 0 to 0.2 μm.

The periodic structure layer 110 may further include a plurality of extending portions 110d extending along the X-axis direction. In the Y-axis direction, each of the first portion 110a and the second portion 110b are disposed between the plurality of extending portions 110d. Each extending portion 110d is disposed between the base layer 110c and the first III-V compound semiconductor layer 120. An example of the material of the extending portion 110d is the same as an example of the material of the second portion 110b.

The first III-V compound semiconductor layer 120 may be supported by a plurality of support layers 112 extending along the X-axis direction. An example of the material of the support layer 112 is the same as the example of the material of the first portion 110a. In the Y-axis direction, each extending portion 110d is disposed between the support layer 112 and the first portion 110a. Each extending portion 110d is a region surrounded by the support layer 112, the base layer 110c, the first portion 110a, and the first III-V compound semiconductor layer 120. In the Y-axis direction, a distance W3 between the plurality of support layers 112 is larger than the width W1 of each of the first portion 110a and the second portion 110b and is smaller than the width W2 of the second III-V compound semiconductor layer 140. The distance W3 corresponds to the width of the base layer 110c.

The periodic structure layer 110 may have a thickness T110 smaller than a thickness T120 of the first III-V compound semiconductor layer 120. The thickness T110 may be 0.1 to 0.5 μm. The thickness T110 is the sum of the thickness T110c of the base layer 110c and the thickness T110a of the first portion 110a.

The first III-V compound semiconductor layer 120 may include at least one of indium phosphide (InP), indium gallium arsenide phosphide (InGaAsP), aluminum indium gallium arsenide (AlInGaAs), gallium arsenide (GaAs), or aluminum gallium arsenide (AlGaAs). An example of an n-type dopant includes silicon (Si). The first III-V compound semiconductor layer 120 may have the width W2 larger than the distance W3 between the plurality of support layers 112 in the Y-axis direction. The first III-V compound semiconductor layer 120 may have a thickness T120 smaller than a thickness T130 of the core layer 130. The thickness T120 of the first III-V compound semiconductor layer 120 may be 0.1 to 0.4 μm.

The core layer 130 includes a non-doped III-V compound semiconductor layer. The core layer 130 may have a multiple quantum well structure or may be a bulk layer. An example of the III-V compound semiconductor layer includes InGaAsP and AlInGaAs. The core layer 130 has the thickness T130. The thickness T130 may be 0.1 to 0.5 μm.

The second III-V compound semiconductor layer 140 may include at least one of InP, InGaAsP, AlInGaAs, GaAs, or AlGaAs. An example of p-type dopant includes zinc (Zn). A thickness T140 of the second III-V compound semiconductor layer 140 may be larger than the thickness T120, or may be larger than the thickness T130. The thickness T140 of the second III-V compound semiconductor layer 140 may be 0.1 to 0.4 μm.

The optical waveguide structure WS may be covered with an insulating film such as a silicon oxide film or benzocyclobutene (BCB). The insulating film may have an opening on the second III-V compound semiconductor layer 140. The electrode E1a (see FIG. 1) is provided in the opening. The electrode E1a is connected to the second III-V compound semiconductor layer 140. A ground electrode is connected to the first III-V compound semiconductor layer 120. A voltage is applied between the electrode E1a and the ground electrode. For example, a reverse bias voltage of a direct current and an alternating-current voltage are superimposed and applied between the electrode E1a and the ground electrode. As a result, an electric signal flows between the electrode E1a and the ground electrode. The electrical signal changes the refractive indices of the first III-V compound semiconductor layer 120, the core layer 130, and the second III-V compound semiconductor layer 140. A phase of the light propagating through the optical waveguide structure WS is modulated by the change in the refractive index.

The light propagating through the core layer 130 may propagate through the periodic structure layer 110, the first III-V compound semiconductor layer 120, and the second III-V compound semiconductor layer 140.

According to the optical modulator 1, the refractive index of the optical waveguide structure WS can be increased by the periodic structure layer 110 having a high refractive index. Further, according to the optical modulator 1, a higher group refractive index (for example, 7 or more) is obtained as compared with an optical waveguide structure not including the periodic structure layer 110. When the group refractive index is high, a large phase change amount is obtained. Thus, the lengths of the electrodes E1a, E1b, E2a, and E2b in the X-axis direction (see FIG. 1) can be shortened, and the modulation bandwidth of the optical modulator 1 can be widened.

When the width W1 of the first portion 110a is smaller than the width W2 of the first III-V compound semiconductor layer 120, light can be confined in a width direction (Y-axis direction) by the periodic structure layer 110.

When the first portion 110a is disposed at the pitch PT1 smaller than a pitch equivalent to a wavelength of light propagating through the core layer 130 in the X-axis direction, light may propagate through the periodic structure layer 110 in the X-axis direction. Since the periodic structure layer 110 has a high refractive index, the velocity of light propagating through the periodic structure layer 110 is reduced. Thereby, slow light is generated.

When the first III-V compound semiconductor layer 120 has the thickness T120 smaller than the thickness T130 of the core layer 130, light propagating through the core layer 130 is likely to leak from the core layer 130 to the periodic structure layer 110 through the first III-V compound semiconductor layer 120.

When the thickness T140 of the second III-V compound semiconductor layer 140 is 0.4 μm or less, a high group refractive index is obtained.

The optical waveguide structure WS can be fabricated as follows. First, the second III-V compound semiconductor layer 140, the core layer 130, and the first III-V compound semiconductor layer 120 are sequentially stacked on a surface of a III-V compound semiconductor substrate. The III-V compound semiconductor substrate is, for example, an InP substrate or a GaAs substrate. Each layer is formed by, for example, a metal organic chemical vapor deposition (MOCVD) method or a molecular beam epitaxy (MBE) method.

Next, the III-V compound semiconductor substrate is cut along scribe lines formed on the surface of the III-V compound semiconductor substrate, thereby forming a plurality of chips.

The optical waveguides and the periodic structure layer 110 are formed by patterning a silicon layer located on a surface of a silicon on insulator (SOI) substrate.

Next, the chip is bonded to the SOI substrate so that the first III-V compound semiconductor layer 120 is bonded to the periodic structure layer 110. The bonding is performed by a surface activated bonding using nitrogen plasma, for example. After the surface of the SOI substrate and the surface of the chip are exposed to nitrogen plasma, the surface of the chip is brought into contact with the surface of the SOI substrate. The SOI substrate and the chip are then heated while a load is applied.

Next, the III-V compound semiconductor substrate of the chip is removed by, for example, wet etching. The III-V compound semiconductor substrate is peeled off by removing the peeling layer.

Next, the second III-V compound semiconductor layer 140, the core layer 130, and the first III-V compound semiconductor layer 120 are processed by photolithography and etching. Thus, the optical waveguide structure WS is formed. Then, an insulating film covering the optical waveguide structure WS is formed. Then, an opening is formed in the insulating film by photolithography and etching. Thereafter, the electrode E1a is formed in the opening by lift-off.

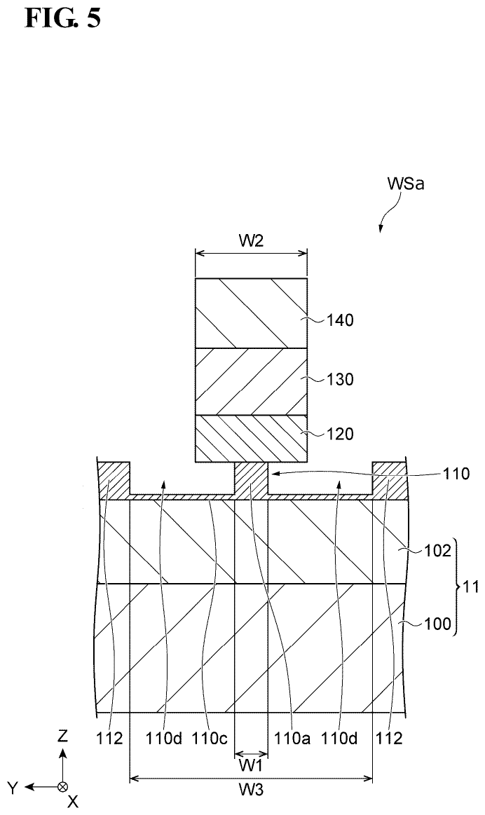

FIG. 5 is a cross-sectional view schematically showing a modification of the optical waveguide structure. An optical waveguide structure WSa shown in FIG. 5 has the same configuration as the optical waveguide structure WS except that the width W2 is smaller than the distance W3. In this case, when the insulating film covering the optical waveguide structure WSa is formed, the insulating film is also formed in the extending portion 110d. Since the optical waveguide structure WSa has the small width W2, the optical waveguide structure WSa has a high optical confinement property in the width direction (Y-axis direction).

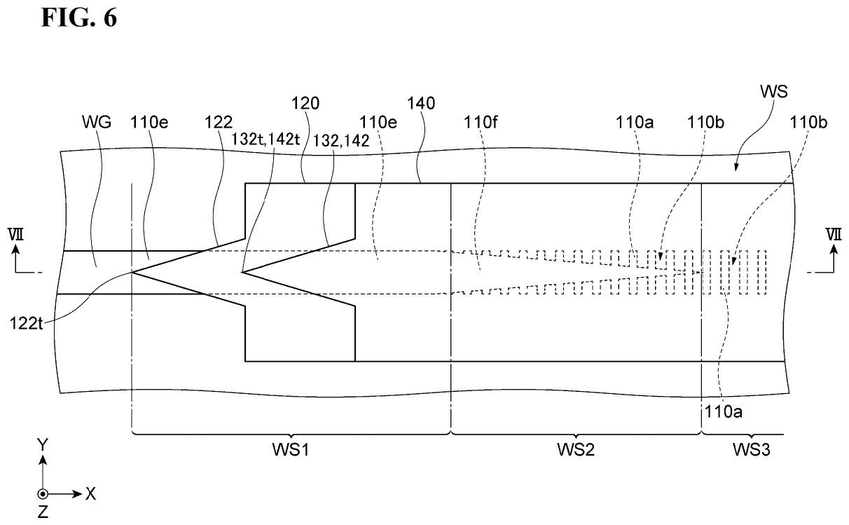

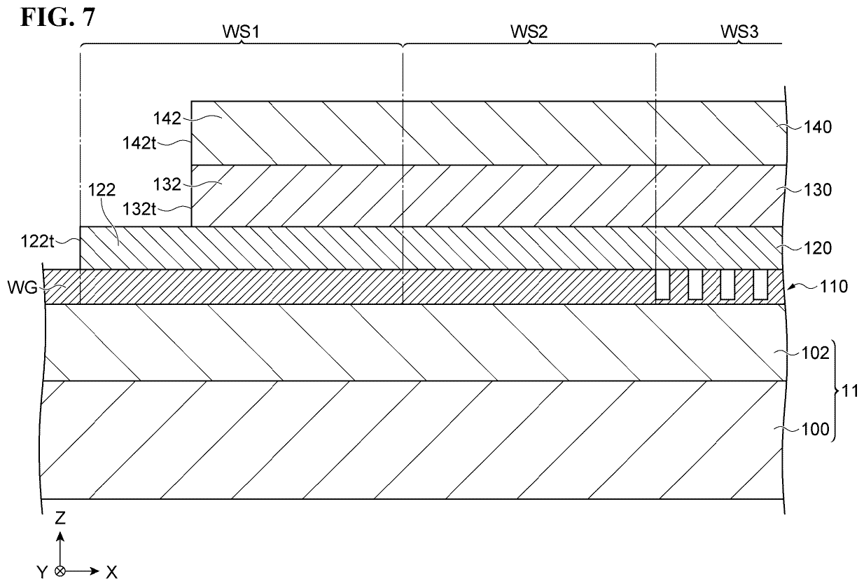

FIG. 6 is a plan view schematically showing a part of the optical modulator of FIG. 1. FIG. 6 shows an end portion of the optical waveguide structure WS. FIG. 7 is a cross-sectional view taken along line VII-VII of FIG. 6. As shown in FIG. 6, the optical waveguide structure WS may include a first region WS1, a second region WS2, and a third region WS3. The first region WS1, the second region WS2, and the third region WS3 are arranged along the X-axis direction. The direction from the first region WS1 to the third region WS3 is the X-axis direction. The first region WS1 is located at the end portion of the optical waveguide structure WS in the X-axis direction. The second region WS2 is disposed between the first region WS1 and the third region WS3.

The periodic structure layer 110 may include the first portion 110a and the second portion 110b in the third region WS3.

The periodic structure layer 110 may include a third portion 110e extending in the X-axis direction in the first region WS1. The third portion 110e has a refractive index larger than the refractive index of the first III-V compound semiconductor layer 120. An example of the material of the third portion 110e is the same as the example of the material of the first portion 110a. A width and thickness of the third portion 110e may be the same as the width and thickness of the first portion 110a.

The third portion 110e is connected to an optical waveguide WG between the first arm waveguide of the Mach-Zehnder modulator portion MZ1 and the first arm waveguide of the Mach-Zehnder modulator portion MZ3. An example of the material of the optical waveguide WG is the same as the example of the material of the first portion 110a. A width and thickness of the optical waveguide WG may be the same as the width and thickness of the first portion 110a.

The periodic structure layer 110 may include the first portion 110a, the second portion 110b, and a fourth portion 110f extending in the X-axis direction in the second region WS2. The fourth portion 110f partially overlaps with the first portion 110a and the second portion 110b. In the second region WS2, the first portion 110a and the second portion 110b are alternately disposed in the X-axis direction. The pitch PT1 at which the first portion 110a is disposed may increase from the first region WS1 toward the third region WS3. The fourth portion 110f has a tapered shape with a width that decreases from the first region WS1 toward the third region WS3. The fourth portion 110f may be triangular when viewed from the Z-axis direction. At the boundary between the first region WS1 and the second region WS2, the width of the fourth portion 110f may be the same as the width of the first portion 110a. At the boundary between the second region WS2 and the third region WS3, the fourth portion 110f may have a tip end. A thickness of the fourth portion 110f may be the same as the thickness of the first portion 110a.

The first III-V compound semiconductor layer 120 may have a first tapered portion 122 in the first region WS1. The first tapered portion 122 has a width that increases from the first region WS1 toward the third region WS3. The first tapered portion 122 may have a triangular shape when viewed from the Z-axis direction. The first tapered portion 122 may have a tip end 122t located on the third portion 110e of the periodic structure layer 110. The tip end 122t of the first tapered portion 122 may overlap the third portion 110e of the periodic structure layer 110 when viewed from the Z-axis direction.

The core layer 130 may have a second tapered portion 132 in the first region WS1. The second III-V compound semiconductor layer 140 may have a second tapered portion 142 in the first region WS1. Each of the second tapered portions 132 and 142 has a width that increases from the first region WS1 toward the third region WS3. Each of the second tapered portions 132 and 142 may have a triangular shape when viewed from the Z-axis direction. The second tapered portions 132 and 142 may have tip ends 132t and 142t, respectively, located above the third portion 110e of the periodic structure layer 110. The tip ends 132t and 142t of the second tapered portions 132 and 142 may overlap with the third portion 110e of the periodic structure layer 110 when viewed from the Z-axis direction. In the X-axis direction, the tip ends 132t and 142t of the second tapered portions 132 and 142 may be located closer to the second region WS2 than tip end 122t of the first tapered portion 122.

When the periodic structure layer 110 includes the first portion 110a, the second portion 110b, and the fourth portion 110f in the second region WS2, light can propagate through the periodic structure layer 110 from the first region WS1 to the third region WS3.

When the first III-V compound semiconductor layer 120 has the first tapered portion 122 and the core layer 130 has the second tapered portion 132, light can propagate from the third portion 110e of the periodic structure layer 110 to the second tapered portion 132 through the first tapered portion 122 in the first region WS1.

Hereinafter, various experiments performed for evaluation of the optical modulator 1 will be described. The experiments described below are not intended to limit the present invention.

### (Calculation of Group Refractive Index)

For the optical waveguide structure WSa shown in FIG. 5, the group refractive index was calculated by simulation calculation (Finite Difference Time Domain method: FDTD method). The optical waveguide structure used in the simulation calculation is as follows. The periodic structure
layer 110: silicon layer,
the first portion 110a: silicon portion,
the second portion 110b: air gap portion,
the first III-V compound semiconductor layer 120 (lower cladding layer): n-type InP layer, the core layer 130: multiple quantum well structure including InGaAsP,
the second III-V compound semiconductor layer 140 (upper cladding layer): p-type InP layer,
the width W1: 0.8 μm,
the width W2: 1.3 μm,
the thickness T110a: 0.18 μm,
the thickness T110: 0.22 μm,
the pitch PT1: 0.3 μm or 0.33 μm (the length of the silicon portion is the same as the length of the air gap portion).

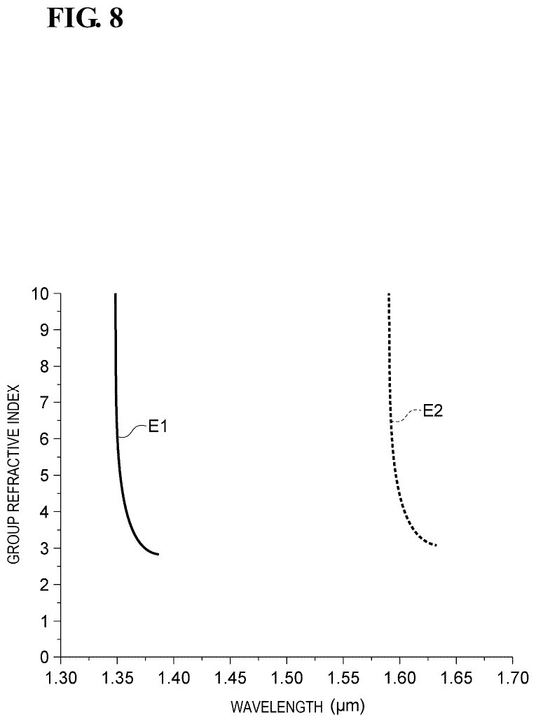

The results of the simulation calculations are shown in FIGS. 8 to 11. In each figure, the horizontal axis indicates the wavelength (μm). The vertical axis indicates the group refractive index.

FIG. 8 is a graph showing an example of the group refractive index when the pitch is changed. E1 shows the result when the pitch PT1 is 0.3 μm. E2 shows the result when the pitch PT1 is 0.33 μm. As shown in FIG. 8, when the pitch PT1 is changed, the wavelength range in which a high group refractive index is obtained changes. Thus, it is understood that a high group refractive index can be obtained in a desired wavelength range by changing the pitch PT1.

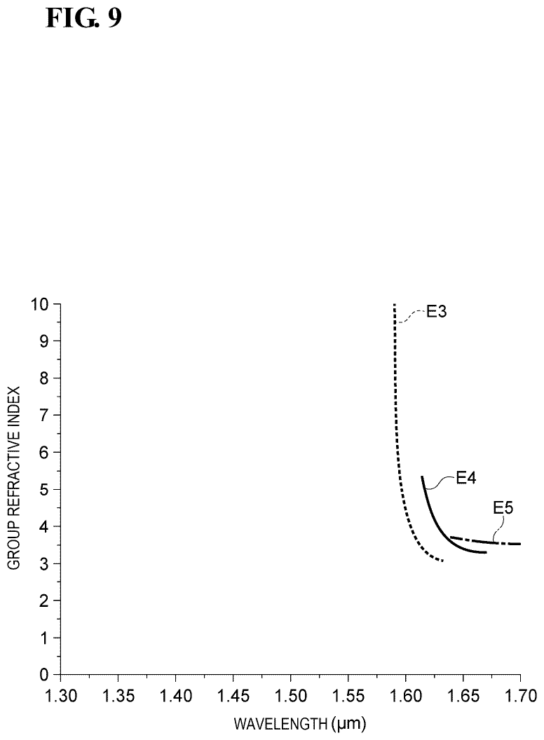

FIG. 9 is a graph showing an example of the group refractive index when a thickness of the upper cladding layer is changed. E3 shows the result when the upper cladding layer is 0.4 μm. E4 shows the result when the upper cladding layer is 0.5 μm. E5 shows the result when the upper cladding layer is 0.6 μm. As shown in FIG. 9, when the thickness of the upper cladding layer is changed, the maximum value of the obtained group refractive index changes. Thus, it is understood that a high group refractive index can be obtained by setting the thickness of the upper cladding layer to 0.4 μm or less.

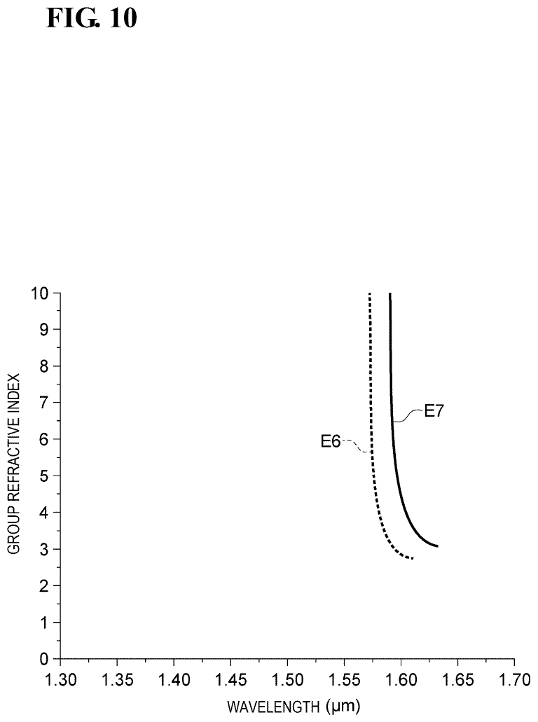

FIG. 10 is a graph showing an example of the group refractive index when the thickness of the lower cladding layer is changed. E6 shows the result when the thickness of the lower cladding layer is 0.25 μm. E7 shows the result when the thickness of the lower cladding layer is 0.3 μm. As shown in FIG. 10, even when the thickness of the lower cladding layer is changed, a high group refractive index is obtained.

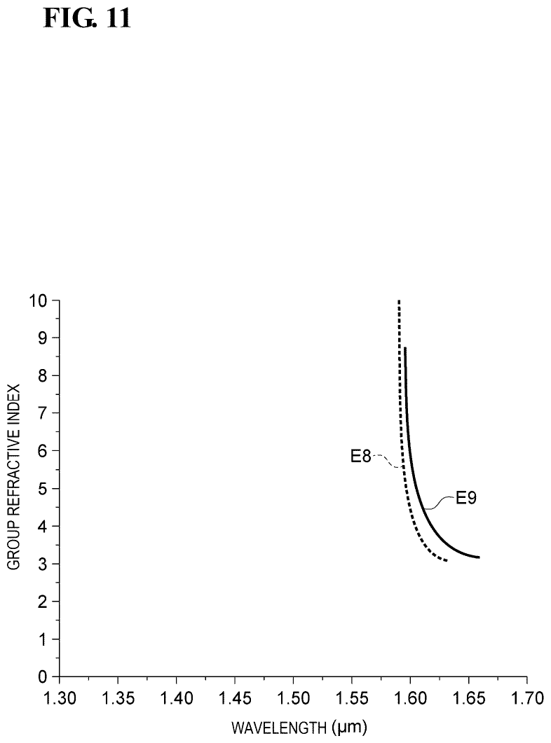

FIG. 11 is a graph showing an example of the group refractive index when a thickness of the core layer is changed. E8 shows the result when the thickness of the core layer 130 is 0.398 μm. E9 shows the result when the thickness of the core layer 130 is 0.432 μm. As shown in FIG. 11, even when the thickness of the core layer 130 is changed, a high group refractive index is obtained.

For the mesa waveguide not including the periodic structure layer 110, the group refractive index was calculated by simulation calculation (FDTD method). The structure of the mesa waveguide used in the simulation calculation is as follows. The width of the mesa waveguide is the same as the width of the lower cladding layer, the core layer, and the upper cladding layer.
The lower cladding layer: n-type InP layer,
the core layer: multiple quantum well structure including InGaAsP,
the upper cladding layer: p-type InP layer.

As a result of the simulation calculation, the group refractive index of the mesa waveguide was 3.6 to 3.8. The equivalent refractive index of the core layer of the mesa waveguide is substantially the same as the equivalent refractive index of the core layer 130 of the optical waveguide structure WSa described above. The phase change amount is proportional to the group refractive index and the length of the electrode. The group refractive index of the optical waveguide structure WSa described above is about 10, which is about 2.5 times the group refractive index of the mesa waveguide. Thus, in the optical waveguide structure WSa, the length of the electrode can be shortened to about 1/2.5 compared to the mesa waveguide.

Although the preferred embodiments of the present disclosure have been described in detail, the present disclosure is not limited to the above embodiments.

The embodiments disclosed herein are to be considered in all respects as illustrative and not restrictive. The scope of the present invention is defined not by the above description but by the appended claims, and is intended to include any modifications within the meaning and scope equivalent to the appended claims.

What is claimed is:

1. An optical modulator comprising:
an optical waveguide structure extending along a first direction,
wherein the optical waveguide structure includes:
a first III-V compound semiconductor layer of a first conductivity type;
a second III-V compound semiconductor layer of a second conductivity type;
a core layer disposed between the first III-V compound semiconductor layer and the second III-V compound semiconductor layer; and
a periodic structure layer,
wherein the first III-V compound semiconductor layer is disposed between the periodic structure layer and the core layer,
wherein the periodic structure layer includes a first portion and a second portion that are alternately disposed in the first direction,
wherein the first portion has a refractive index larger than a refractive index of the first III-V compound semiconductor layer, and
wherein the second portion has a refractive index smaller than a refractive index of the first portion.

2. The optical modulator according to claim 1,
wherein the first portion has a width smaller than a width of the first III-V compound semiconductor layer.

3. The optical modulator according to claim 1,
wherein the first portion includes silicon.

4. The optical modulator according to claim 1,
wherein the second portion includes an air gap or silicon oxide.

5. The optical modulator according to claim 1,
wherein the first portion is disposed at a pitch smaller than a pitch equivalent to a wavelength of light propagating through the core layer in the first direction.

6. The optical modulator according to claim 1,
wherein the first III-V compound semiconductor layer has a thickness smaller than a thickness of the core layer.

7. The optical modulator according to claim 1,
wherein the second III-V compound semiconductor layer has a thickness of 0.4 μm or less.

8. The optical modulator according to claim 1, further comprising:
a substrate,
wherein the periodic structure layer is disposed between the substrate and the first III-V compound semiconductor layer.

9. The optical modulator according to claim 1,
wherein the optical waveguide structure includes a first region, a second region, and a third region,
the first region, the second region, and the third region are arranged along the first direction,
the first region is located at an end portion of the optical waveguide structure in the first direction,
the second region is disposed between the first region and the third region,
the periodic structure layer includes the first portion and the second portion in the third region,
the periodic structure layer includes a third portion extending in the first direction in the first region, the third portion having a refractive index larger than the refractive index of the first III-V compound semiconductor layer, and
in the second region, the periodic structure layer includes the first portion, the second portion, and a fourth portion extending in the first direction, the fourth portion having a tapered shape with a width that decreases from the first region toward the third region.

10. The optical modulator according to claim 9,
wherein the first III-V compound semiconductor layer has a first tapered portion in the first region, the first tapered portion having a width that increases from the first region toward the third region,
the core layer has a second tapered portion in the first region, the second tapered portion having a width that increases from the first region toward the third region,
each of the first tapered portion and the second tapered portion has a tip end on or above the third portion of the periodic structure layer, and
in the first direction, the tip end of the second tapered portion is located closer to the second region than the tip end of the first tapered portion.
